(19) United States
(12) Patent Application Publication
(10) Pub. No.: US 2024/0215607 A1
(43) Pub. Date: Jul. 4, 2024

(54) PROTEIN PREPARATION PRODUCED FROM PUMPKIN SEEDS AND PREPARATION METHOD

(71) Applicant: Fraunhofer-Gesellschaft zur Förderung der Angewandten Forschung E.V., München (DE)

(72) Inventors: Peter EISNER, Freising (DE); Andreas STÄBLER, Freising (DE); Stephanie MITTERMAIER, Freising (DE); Dominic WIMMER, Freising (DE); Klaus SCHREIBER, Freising (DE); Isabel MURANYI, Freising (DE)

(21) Appl. No.: 18/255,216

(22) PCT Filed: Nov. 18, 2021
(86) PCT No.: PCT/EP2021/082077

§ 371 Date: May 31, 2023

(30) Foreign Application Priority Data
Nov. 24, 2020 (DE) 102020131026.9
Nov. 18, 2021 (WO) PCT/EP2021/082077

(51) Int. Cl. A23J 1/14; A21D 2/26; A21D 13/80; A23K 10/30; A23K 20/147; A23K 50/40

(52) U.S. Cl. CPC A23J 1/144; A21D 2/266; A21D 13/80; A23J 1/148; A23K 10/30; A23K 20/147; A23K 50/40

(57) ABSTRACT

The present invention relates to a protein preparation produced from pumpkin seeds and a cost-effective method for the preparation thereof. The protein preparation has a protein content or more than 60% by mass, a fat content of less than 6% by mass and a brightness L* of greater than 70. The protein preparation has a neutral taste, is bright and of superior quality so that it is suitable for foodstuff applications with high colour demands such as drinks and yoghurts and fine bakery goods such as cakes or also for emulsions such as cremes and fillings.

### FIELD OF APPLICATION

The invention relates to a protein preparation for foodstuffs, petfood and animal feed produced from pumpkin seeds that is appealing to the senses, and a method for obtaining pumpkin seed protein ingredients of such kind.

### PRIOR ART

As farmland and phosphorus and other resources become increasingly scarce, plant-based protein preparations are becoming more and more important for feeding humans and for use in animal feed. The growing demand for superior quality foodstuffs gives rise to an increasing need for nutritionally and technofunctionally optimised protein preparations that can be provided simply and cost-effectively.

In this context, vegetable proteins that can be mixed as a blend component with soya and pea proteins in order to compensate for the methionine deficiency in these leguminous proteins are becoming increasingly important. This may be achieved with proteins produced from pumpkin seeds for example, as these have a high methionine content.

A cost-effective source of proteins for foodstuffs, animal feed and petfood are the press and extraction residues obtained as by-products when cooking oil is produced from pumpkin seeds. After shelling, pumpkin seeds have thin, pale to dark green integument which is difficult if not impossible to separate from the cotyledons. In these raw substances, it is not desirable to separate the integument before recovering the oil, as it is actively intended to produced a green colour in the oil. This is why, when pressing to obtain pumpkin seed oil according to the prior art, the seeds are heat treated before de-oiling to obtain roasting flavours, and then pressed. At high temperatures of more than 100° C., press cakes are then obtained with an oil content less than 15% by mass, often less than 10% by mass. These can be ground into a powder and added to foodstuffs and animal feed. Because of the harsh treatment at high temperatures, press cakes of such kind most often have a dark, brownish-green colour. Moreover, the integument content results in a green colour of the press cakes, which reduces their acceptance in food applications. Due to its content of unsaturated fatty acid, the residual fat in the oil-containing press cake also tends to oxidise, which impairs the sensory characteristics very quickly during storage. Compared with isolates from soya (protein content >90%) or pea (protein content >80%), pumpkin seed preparations of such kind also have a protein concentration of less than 60% by mass, so that it is difficult or impossible to use in many foodstuff applications.

Pumpkin seed preparations are also known in which the fat content is reduced to values below 2% by mass with supercritical CO₂ after pressing, which improves storage stability. However, this method entails very high costs. Additionally, the extraction takes place at high pressure of several hundred bar in very expensive reactors, the manufacture and operation of which is associated with high CO₂ emissions. Since the process requires a great deal of energy, and after relaxation large quantities of CO₂ are released from the de-oiled flour, protein flours that are extracted by means of supercritical CO₂ have no clear ecological advantages over animal proteins and also entail similarly high costs for their preparation. Furthermore, the colour of these preparations is still dark green, which is also not conducive to their acceptance in foodstuff applications.

The object of the present invention consisted in providing a vegetable protein preparation that has a neutral taste, a largely bright colour and superior quality, and a cost-effective preparation method, which is suitable for use in foodstuff applications with high flavour demands such as drinks and yoghurt, and fine bakery goods such as cakes or also for emulsions such as cremes and fillings. The protein content of the preparation should advantageously be as high as possible, so that even in small amounts it contributes to protein enrichment in foodstuffs, or even in smaller doses it helps to compensate for the methionine deficit when mixed with leguminous protein.

### DESCRIPTION OF THE INVENTION

The object is solved with the protein preparation according to claim 1 and the preparation method therefor according to claim 14. Advantageous variants of the method and the protein preparation are described in the subordinate claims as well as the following description and the exemplary embodiment.

Suitable raw material for manufacturing the protein preparation according to the invention may consist of cleaned and shelled pumpkin seeds having a dry integument content of less than or equal to 100% by mass, advantageously less than 75% by mass, preferably less than 50% by mass, particularly preferably less than 10% by mass relative to the dry integument contained in native seeds. The preparation according to the invention is characterized by the following properties (the methods of determination are listed at the end of the description):
The fat content of the preparation is less than 6% by mass, advantageously less than 4% by mass, preferably less than 3% by mass, particularly advantageously less than 2% by mass, in each case relative to the dry matter (DM) of the preparation.
The protein content of the preparation is more than 60% by mass, advantageously more than 70% by mass, preferably more than 75% by mass, particularly advantageously more than 78% by mass (relative to TS).
The preparation has a bright colour, wherein the L* value after grinding to a particle size d₉₀ (d₉₀: fraction of 90% of the mass of all particles less than the value specified) below 250 μm is more than 70, advantageously more than 80, particularly advantageously more than 90. The L* value in a 10% aqueous suspension is more than 70, advantageously more than 80, particularly advantageously more than 85 (see Table 1).

Preferred (optional in each case) additional properties of the preparation:
The preparation contains a residual content of pumpkin seed integument of less than 10% by mass, preferably less than 6% by mass, advantageously less than 3% by mass, particularly preferably less than 1% by mass.
The preparation contains a fraction of water-soluble carbohydrates. Since sucrose constitutes the largest part of the water-soluble carbohydrates, in the following they will be indicated as sucrose contents. The sucrose content is less than 4% by mass, advantageously less than 2% by mass, preferably less than 1.5% by mass, particularly advantageously less than 1% by mass.
The particle size of the preparation advantageously has a d₉₀ value less than 500 μm, preferably less than 250 μm, advantageously less than 150 μm, particularly advantageously less than 100 μm.
The preparation has good to very good technofunctional properties. Thus for example, particularly the water binding capacity is greater than 1 mL/g, advantageously greater 2 than mL/g, particularly advantageously greater than 3 mL/g, and the oil binding capacity is greater than 1 mL/g, advantageously greater than 2 mL/g, particularly advantageously greater than 2.5 mL/g. The preparation has an emulsifying capacity of more than 250 mL/g, advantageously more than 350 mL/g, preferably more than 400 mL/g, particularly advantageously more than 500 mL/g. Surprisingly, despite their low solubility, in some cases less than 15%, the preparations according to the invention have proven to be ideally suitable as an ingredient for dairy alternatives.
The preparation contains fractions of alcohol, particularly, ethanol, more than 0.001% by mass, preferably >0.01% by mass, advantageously >0.1% by mass, particularly advantageously >0.5% by mass, but in all cases less than 1% by mass. In this context, it was found that the functional properties of the preparation are at a very high level even with a content of 0.5% by mass.
The preparation contains fractions of hexane greater than 0.0005% by mass, preferably >0.001% by mass but less than 0.005% by mass. Preparations with hexane contents of this order exhibit better functional properties in comparison to preparations with lower hexane content.

With respect to the properties of the preparation in the present patent application, the values stated in % by mass refer in each case to the dry matter or dry substance of the protein preparation, with the exception of the solvent fractions, which are specified as an absolute mass fraction.

TABLE 1
Colour values for pumpkin seed protein preparation of the exemplary
embodiment as ground flour and in a 10% suspension

| | Colour value | | |
|---|---|---|---|
| Colour values | L* | a* | b* |
| Protein preparation as flour | 91.9 | −0.94 | 11.31 |
| Aqueous suspension with 10% by | 86.8 | −0.8 | 23.37 |
| mass flour | | | |

Surprisingly, solvent-containing preparations with the stated solvent contents still exhibit very good properties in terms of technofunctionality, such as the ability to be textured in the extruder with the formation of solid gel structures, although the protein content is in the same order of magnitude as for protein isolates (e.g., pea protein isolates), which exhibit significant loss of functionality in the presence of solvents such as ethanol.

In advantageous variants, the preparation has additional properties, which can be of great benefit in various food applications. For example, the amount of sucrose originally contained in the seeds may be reduced relative to the protein content with the aid of suitable methods, so that the ratio of proteins to sucrose is significantly greater in the protein preparation than in the shelled pumpkin seeds with integument. This may bring advantages in terms of avoiding the initiation of undesirable Maillard reactions when preparing foods, as Maillard products change the colour of the food that is produced with the proteins, lending the food a darker appearance and a Maillard flavour. This is undesirable, particularly for foodstuffs such as milk or yoghurt alternatives or fine baked and sweet goods or delicatessen products. Accordingly, the carbohydrate-reduced pumpkin seed protein preparation according to the invention is particularly well suited for use in the preparation of foodstuffs with high sensory standards which should only contain small quantities of Maillard products.

It has been found that a reduction of the sucrose content in the protein preparation to values below 50% relative to the water-soluble carbohydrate content already significantly reduces the Maillard reaction, during an extrusion for example, or when the protein is baked at temperatures above 130° C., and the final product remains lighter and more neutral to the senses than if a preparation is processed with the amount of sucrose originally contained in the seeds.

Surprisingly, it is possible to achieve protein contents of more than 76% by mass in the preparation m according to the invention—after advantageous performance of the method according to the invention—, without dissolving the proteins in water beforehand, as is necessary when preparing protein isolates according to the prior art. In this way, protein contents may be obtained which are present in almost the same order of magnitude as those of pea protein isolates, at levels slightly above 80%, using a very simple, cost-effective and extremely sustainable method without dissolving the proteins out of the press cake matrix.

### Description of the Method for Preparing the Protein Preparation:

The method according to the invention includes a number of substeps, wherein shelled and cleaned pumpkin seeds are provided that contain an integument fraction between 0 and 100% of the integument originally attached to the seeds. These pumpkin seeds undergo a mechanical de-oiling process, preferably in a continuous press such as a screw press, an extruder, or a discontinuous hydraulic press which is advantageously operated quasi-continuously in an integrated system of multiple single presses, the press cakes or partially de-oiled pumpkin seeds obtained thereby then have most of their oil and sucrose content removed by solvent extraction, advantageously after setting a defined particle size and setting a defined water content in the press cake or the partially de-oiled pumpkin seeds. Then, the one or more solvent (s) is/are separated from the preparation. To conclude, the preparation is preferably ground to achieve a defined particle size distribution.

The process may advantageously be accompanied by sieving and sifting processes, by which fractions containing integument can be separated before, during and after processing of the seeds. The following section describes the substeps of the suggested method in greater detail, some of which are optional.

Cleaning: In a first step, cleaned pumpkin seeds are provided, or impurities or contaminants are removed from pumpkin seeds by mechanical methods. The fraction of contaminants is thus reduced to less than 0.5% by mass, advantageously less than 0.2% by mass, preferably less than 0.1% by mass, particularly advantageously less than 0.05% by mass, and/or pumpkin seeds with a corresponding low contaminant fraction are provided.

Partial separation of the integument: In the follow, optional, step, the integument is at least partially separated from the pumpkin seeds. For this, abrasive methods may be implemented, which remove at least some of the integument by grating, shearing or scraping the surface of the pumpkin seeds. The integument fraction with portions of cotyledons attached that is removed in this process is preferably supplied to a separate oil recovery process, the pumpkin seeds from which some or all of the integument has been removed are forwarded for further processing according to the invention. As an alternative method for reducing the integument fraction, the separation may be carried out under moist or wet conditions, advantageous at elevated temperatures. In such a case, the pumpkin seeds are heated or boiled before the hard shells are removed, and the integument is grated off mechanically after the hard shells have been removed. It may also be carried out in a similar way if the previously shelled pumpkin seeds are softened in water, boiled, and the integument is then separated, as is known when from shelling almonds. The method according to the invention is advantageously carried out with pumpkin seeds from which the integument has been partially, mostly or completely removed as the raw material. For this purpose, a process is advantageously performed beforehand in which the seeds with little or no integument content are separated or sorted from the those with more integument. However, it is also possible to perform the method with the complete pumpkin seeds as obtained, and only to separate parts of the integument, with sieves for example, at a later time (after de-oiling for example).

Conditioning: In a variant, a conditioning of the seeds with adjustment of the seeds' temperature and moisture is carried out before the mechanical partial de-oiling, optionally after the seeds are crushed. For this, the water content in the seeds is adjusted to between 2 and 8% by mass, preferably between 3 and 6% by mass, particularly advantageously between 4 and 5.5% by mass. A coarse crushing of the seeds to an edge length of 0.5 to 7 mm, advantageously between 0.5 and 5 mm, particularly advantageously between 0.5 and 2 mm is also advantageously carried out before the mechanical partial de-oiling. With coarse crushing, in an impact mill or granulator for example, relevant fractions of the integument can be flaked off, which may advantageously be separated from the seeds by sifting or other separation processes. This improves the colour of the pumpkin seed protein preparations. It is also advantageous to warm the seeds to a temperature above 40° C., advantageously above 50° C., preferably higher 60° C., particularly advantageously above 75° C. before or after the crushing and before the pressing. After this kind of conditioning, the pumpkin seeds are particularly well prepared for processing in a continuous press. According to the invention, the pressing or another technique for mechanical partial de-oiling may be carried out either with pumpkin seeds on which the integument is still entirely intact, or with seeds on which the integument has been partially or completely separated by suitable pre-treatment.

Mechanical partial de-oiling: With the pumpkin seeds, a mechanical separation of the oil from the seeds is carried out, advantageously with apparatuses for continuous de-oiling. Examples of such machines are screw presses, extruders or quasi-continuous hydraulic presses, but other mechanical apparatuses for separating oil may also be used, such as centrifugal separating technologies. In case of the particularly advantageous compression of the seeds to yield press cakes and oil using screw presses or extruders, the pressing is performed in such manner that the residual oil content after pressing is more than 8% by mass but less than 40% by mass, the residual oil content is advantageously between 8 and 30% by mass, preferably between 8 and 25% by mass, and particularly advantageously between 8 and 20% by mass. The definition of the lower limit of 8% by mass residual oil content is chosen because further oil separation requires considerably higher temperatures, which may be instrumental in in damaging the proteins. These values are also valid if presses are not used, but other types of mechanical partial de-oiling are used instead.

Pumpkin seeds have an oil content of as much as 55%, and because they lack any components that lend structure for drainage, it is not easy to de-oil them mechanically. However, in order to reduce the quantity of solvent needed for de-oiling, the objective is to reach a residual oil content of less than 25% by mass in the press cake or the partially de-oiled pumpkin seeds after pressing. For this reason, it may be necessary to press the press cake in a press again or carry out another mechanical partial de-oiling process. This may be carried out during the pressing, for example by adding the press cake to the feed for the first pressing together with unpressed seeds, or in another, second press, which is only used to press the press cake further. The pressing of the press cake may also be carried out multiple times in order to arrive at the desired residual oil content. With repeated pressing of press cakes or repeated mechanical partial de-oiling, it is possible in the end to achieve the desired low residual oil content without having to set excessively high temperatures. To avoid damaging the proteins too severely through repeated mechanical partial de-oiling, according to the invention pressing or mechanical partial de-oiling take place at moderate temperatures. The pumpkin seeds are pressed or mechanical partially de-oiled at an mean temperature below 100° C., particularly advantageously at less than 80° C. In this context, the mean temperature is understood to be arithmetical average of the temperature of the seeds at the intake and the temperature of the press cakes or partially de-oiled pumpkin seeds at the discharge from the press or mechanical partial de-oiling device. This enables gentle pressing of the oil despite several passes through the press, without having to anticipate any significant colour changes in the preparation.

Optional conditioning of the press cake or partially de-oiled pumpkin seeds: In an advantageous variant of the method according to the invention, a conditioning of the press cakes or partially de-oiled pumpkin seeds may be carried out before an extraction to separate the remaining oil and reduce the fraction of sucrose in the press cakes or partially de-oiled pumpkin seeds in advance of any further processing. In such a case, it has been found that a reduction of the moisture in the press cakes or partially de-oiled pumpkin seeds, which may be as much as 15% by mass after the mechanical partial de-oiling, to a residual moisture below 8% by mass, advantageously below 5% by mass, preferably below 3% by mass, particularly advantageously below 2% by mass, using dryers for example, makes the de-oiling with organic solvents in the subsequent step more efficient, enabling more oil to be separated using less solvent with lower moisture. This may be used advantageously to lower costs and to enable gentler treatment of the proteins.

It may further be of advantage to change the particle size and particle shape of the press cakes or partially de-oiled pumpkin seeds before the extraction. It has been found that crushing the press cake or partially de-oiled pumpkin seeds to particle sizes with a doo value less than 2 mm, advantageously less than 1 mm, preferably less than 0.5 mm, particularly advantageously less than 0.2 mm, significantly accelerates the drying and extraction process. This acceleration leads to an improvement of the functional properties in the preparations, since the residence time in the dryer and the contact time between solvent and proteins are shortened. But according to the invention, the fraction of fine grain with a particle size less than 100 μm in the crushed press cake or pumpkin seed bulk material should be less than 50% by mass, advantageously less than 25% by mass, particularly advantageously less than 10% by mass.

It is also possible, and for a percolation extraction advantageous, if the press cake or the partially de-oiled pumpkin seeds is or are not ground, but flaked. In such a case, the flake thickness is advantageously adjusted to less than 2 mm, advantageously less than 0.5 mm, particularly advantageously less than 0.2 mm. In this context, flake thickness is understood to refer to the average thickness from the roller mill or another flaking machine. The average thickness can be determined for example by measuring with a calliper gauge or a micrometer screw, this then corresponds to the average from 50 measurements.

The particle size and particle shape of the press cake during mechanical partial de-oiling with a press can be adjusted using various processes. For example, mills or crushers with corresponding sieve inserts or roller mills with defined roller gaps may be used. In this way, particle size distributions with a defined size spectrum may be obtained. These may be homogenised with regard to particle size distribution after or during the grinding by separation according to size, for example by sieving. Fast-flowing liquids in the form of a pressure jet or suspensions containing solids may also be used to comminute the press cake particles. Here, besides liquid nozzles, conveyor units, agitators or mixers with a shearing load of the press cake may also be used. Machines that are already in use in the process for transporting the extraction agent are advantageously used for this as well. Thus, it is possible to use machines that were actually designed for pumping or agitation, for example centrifugal pumps or other forms of transport or agitation machinery, to assist with crushing. By setting a suitable residence time in these units, or by cycle management, it will be possible to adjust the crushing in said devices such that the particle size distribution according to the invention is obtained.

Solvent extraction: In order to separate residual oil and sucrose from the press cakes or mechanically partially de-oiled pumpkin seeds, mixtures of alcohols with water as solvent are used for preference. Then, the treatment with alcohol and the treatment with water may be arranged simultaneously, in the same extraction step (in the form of an alcohol-water mixture), or consecutively. Moreover, hexane may also be used in the presence of water as a solvent, as well as combinations of alcohol or hexane as one solvent and water as another solvent. Ethanol, propanol, isopropanol, for example, or others may be used as alcohols. In order to ensure a substantial separation of the oil from the press cakes or partially de-oiled pumpkin seeds, the mass fraction of solvent relative to the mass fraction of press cake or partially de-oiled pumpkin seeds should be chosen to be more than 1.5 to 1, advantageously more than 3 to 1, preferably more than 5 to 1, more preferably more than 7 to 1, particularly advantageously more than 10 to 1. It is then possible to achieve a substantial reduction of the oil to less than 2% by mass.

When the organic solvents alcohol or hexane are used for the extraction, it is advantageous if a quantity of water is added or an organic solvent with a defined water content is used besides the organic solvent. In such a case, the water may be used while the oil is being extracted with the solvent or not until afterwards. In the event of simultaneous use of organic solvent and water and selection of a suitable water content, not only is it possible to separate a very large proportion of the fat from the press cakes or pumpkin seeds, but the sucrose can also be removed at the same time. For this purpose, the water content in the extraction is chosen to be more than 6% by mass, advantageously more than 7% by mass, preferably more than 8% by mass, particularly advantageously more than 10% by mass relative to the organic solvent. On the other hand, in the case that alcohols are used as the organic solvent, the water content should be chosen to be less than 14% by mass to avoid the situation in which that oil can no longer be dissolved sufficiently. This limitation makes it possible to obtain a technofunctional protein preparation which has a particularly bright colour and a very high protein content.

The addition of the water to the organic solvent may be carried out by providing aqueous solvent, by adding moist press cakes or moist pumpkin seeds, or by adding water directly before or during the solvent-extraction. Combinations of the measures described may also be selected. In a variant, if hexane is used as organic solvent, the water content may also be adjusted such that it constitutes a fraction greater than 14% by mass relative to the hexane. In the case of hexane, the good solubility for oil is retained even if water contents relative to the solvent of for example more than 20 or even 30% by mass are used. Thus, the water content according to the invention is only limited to a maximum of 14% by mass in alcohols, with hexane as solvent this limitation does not apply.

During the treatment of protein-rich press cakes produced from pumpkin seeds with water-alcohol mixtures, it is also possible for the proteins to become denatured as the oil and sucrose are being separated. In order to largely avoid this effect, only a small process window is available for this simultaneous separation step. This includes not only the defined water content, but also the temperature and the residence time. According to the invention, the temperature of the solvent during the extraction will be between 30° C. and 75° C., advantageously between 45° C. and 65° C., particularly advantageously between 50° C. and 65° C. At this temperature, the selected mixtures of water and organic solvent are able to separate both oil and soluble carbohydrates from the pumpkin seeds without at the same time causing excessive denaturation of the proteins. In the method according to the invention, the duration of the contact between organic solvent and the press cake or protein preparation at temperatures above 45° C. is between 30 minutes and 12 hours, advantageously between 1 hour and 5 hours, particularly advantageously 1 to 2 hours. However, the temperature ranges stated above should also be chosen if hexane is used as solvent, in order to avoid thermal damage to the proteins to the extent possible.

For the extraction, a conventional percolation extraction may be implemented, in which the solvent is passed over a bulk quantity of press cake particles or particles that have been conditioned in terms of particle size/shape or moisture, so that oil and sucrose can be eluted into the organic solvent and/or the water. Since fine particles can be detached from the pumpkin seed press cakes and washed out with the solvent in this process, extensive filtration apparatuses must be provided to prevent pumps and pipelines from becoming clogged or to avoid product losses. In order to suppress this process, or at least to limit it, it may be advantageous to press the conditioned or unconditioned press cakes into pellets before the extraction, as considerably fewer fine particles become detached from these during the extraction. In this way, the expense of the filtration may be reduced significantly.

Since a loss of fine particles cannot be entirely prevented during the percolation extraction, it is advantageous to perform an immersion extraction, preferably in a mixing-settling process for example. A multistage immersion extraction is particularly well suited for this. In this process, the press cakes or conditioned press cakes are completely immersed in the solvent. In an immersion extractor, it is possible to comminute the particles with an agitator as described above simultaneously with the extraction. In this way, it is also possible to perform an incremental crushing of the press cakes in several extraction receptacles arranged one behind the other. Following the first extraction step, solvent and raffinate can be separated mechanically, advantageously by sedimentation. The oil-containing miscella in the supernatant can subsequently be distilled, and the recovered solvent can be reused for the extraction of press cake particles with a finer particle size distribution. The press cake (raffinate) separated by solvent may be reacted with fresh solvent, and so undergo de-oiling again. In order to reduce the total quantity of solvent, the solvent supernatant from the treatment of a raffinate charged with less oil may be used again for the extraction of a raffinate charged with more oil, and so on. In this way a counterflow extraction is established with agitation vessels. Alternatively, a counterflow extraction may also be created in a screw, chamber or belt extractor.

A particular advantage of the use of sedimentation is derived from the capability to specify the duration of the sedimentation for adjusting the degree of separation for solid-liquid separation. In this context, following an extraction carried out with defined particle sizes, after the agitator is stopped a sedimentation takes place in the earth's gravity field until a defined volume ratio of raffinate and supernatant is reached. This process may advantageously be supported by a filter floor or sieve floor that accelerates or retards the sedimentation of the particles from above, or by generation of a vacuum underneath a filter below the sedimentation layer (strainer for example). During the sedimentation, it is advisable to separate the supernatant from the raffinate, by suction for example, when a previously defined volume fraction of the supernatant of at least 50%, advantageously more than 60%, particularly advantageously more than 70% is reached.

In the counterflow, the raffinate can be recharged with solvent and the suspension can be agitated until a new particle size distribution is established by the shear forces created during the agitation. The sedimentation process then takes place again. The process of mixing and settling of the raffinate may be repeated multiple times, advantageously the process is performed more than twice, preferably more than three times, particularly advantageously more than four times, with the result that the extraction is performed as a multistage extraction particularly advantageously in the counterflow. In this context, in a variant of the method it is advantageous to use different mixing ratios of organic solvent and water in different stages of the multistage extraction. For example, a higher water content may be used in the first extraction stage in order to selectively separate water-soluble components, and in subsequent extraction steps the water content may be lower to make the de-oiling more efficient, since for example a solvent like ethanol or propanol can dissolve more oil with a lower water fraction. This approach also has the advantage, when using ethanol as solvent for example, that the water content is only high for a short time in the first extraction stage, and consequently the protein denaturation can be minimised. This reveals, surprisingly, that with pumpkin seeds denaturing of the proteins may be reduced if solvents or solvent mixtures with different polarities are used in different extraction stages.

Apart from mixing water and an organic solvent such as ethanol in an extraction step, it may also be advantage to use a lipophilic solvent initially, and then to introduce a hydrophilic or water-containing solvent after partial separation of the solvent or complete desolvation of the raffinate. This may serve to further reduce the stress on the proteins due to the presence of water.

Post-treatment and desolvation of the preparation: Following the extraction with organic solvents and water, in order to improve its functional properties the preparation may optionally undergo further treatment with aqueous enzyme solutions, or fermentation, or it may be dried directly. Drying is advantageously performed at low temperatures, below 120° C., preferably below 100° C., particularly advantageously below 80° C., in order to minimise stress on the proteins and to preserve the brightest possible colour in the preparation. For this purpose, advantageously a dryer is used that can be operated in a vacuum and whose pressure is lowered again at the end of the drying process to separate the solvent residues. The pressure is advantageously reduced to values less than 500 mbar, preferably less than 200 mbar, particularly advantageously less than 100 mbar. This pressure reduction at the end of the drying process may serve to lower the temperature further during the post-drying period, thereby offering further gentle treatment of the proteins.

After drying, the dried protein preparations are advantageously ground to adjust their functionality, as preparations ground to different degrees of fineness exhibit significant differences in their technofunctional properties, such as solubility. Grinding therefore takes place depending on application to d₉₀ particle sizes less than 500 μm, advantageously less than 250 μm, preferably less than 150 μm, particularly advantageously less than 100 μm.

### Description of a Use of the Preparation:

When the preparation produced from pumpkin seeds according to the invention is used, particular advantages are revealed for the preparation of protein mixtures for foodstuffs or petfood due to the comparatively high methionine content of amino acids, more than 2% by mass. A mixture of the preparation according to the invention with protein fractions from leguminous protein of the group of peas, lentils, beans, broad beans, peanuts or soya is advantageous, particularly advantageous only from the group of peas and soya, only with peas is especially advantageous.

A mixture according to the invention should contain >60% by mass, advantageously >70% by mass, particularly advantageously >80% by mass protein content. The ratio of the protein according to the invention relative to the total mass of the mixture should be more than 5% by mass and less than 95% by mass, advantageously more than 10% by mass and less than 90% by mass, particularly advantageously more than 25% by mass and less than 75% by mass, ideally more than 40% by mass and less than 60% by mass. At this value, the functionality of the der leguminous proteins may be combined particularly successfully with the good sensory appeal and colour of the preparation according to the invention.

In the text below, the following determination methods are used to present a quantitative characterisation of the protein preparations produced:

### Protein Content:

Protein content is defined as the content calculated from the determination of nitrogen according to Dumas and multiplying this by a factor of 6.25. In the present patent application, the protein content is expressed in percent by mass relative to the dry matter (DM), that is to say the anhydrous sample.

### Colour:

Perceptible colour is defined using CIE-L*a*b* colour measurement. The L*-axis describes brightness, wherein black has value 0 and white has value 100. The a*-axis describes the green or red component, and the b*-axis describes the blue or yellow component.

### Protein Solubility:

Protein solubility is determined using determination methods according to Morr et al. 1985, see the magazine article: Morr C. V., German, B., Kinsella, J. E., Regenstein, J. M., Van Buren, J. P., Kilara, A., Lewis, B. A., Mangino, M. E, “A Collaborative Study to Develop a Standardized Food Protein Solubility Procedure. Journal of Food Science”, Volume 50 (1985) pages 1715-1718). Protein solubility can be stated for a defined pH value, if no pH value is given, the data refers to a pH value of 7.

### Emulsifying Capacity:

Emulsifying capacity is defined using determination methods (referred to in the following as EC determination methods) in which corn oil is added to 100 ml of a 1% suspension of the protein preparation with pH 7, until phase inversion of the oil-in-water emulsion occurs. Emulsifying capacity is defined as the maximum oil absorption capacity of this suspension, determined via the spontaneous fall in conductivity upon phase inversion (see the magazine article by Wäsche, A., Müller, K., Knauf, U., “New processing of lupin protein isolates and functional properties”. Nahrung/Food, 2001, 45, 393-395) and is expressed for example in ml oil/g protein preparation, i.e. millilitres of emulsified oil per gram of protein preparation

### Fat Content:

Fat content is determined with the Soxhlet method using hexane as solvent.

### Sucrose:

The sucrose content is determined by modified measurement according to DIN 10758: 1997-05 (incl. amendment 1 of September 2018) with HPLC methods. To prepare the samples, the sugars are extracted from the sample matrix using hot water. After separating contaminants, the extracts are filled with water to a defined volume, filtered, and the filtrates are forwarded for HPLC measurement.

### Water Binding:

Water binding capacity is determined as described in: American Association of Cereal Chemists, “Approved methods of the AACC”. 10th ed., AACC. St. Paul, MN, 2000b; Method 56-20. “Hydration capacity of pregelatinized cereal products”. Water binding capacity can be expressed for example in ml/g, i.e. millilitres of bound water per gram of preparation, and is determined according to the AACC determination method based on the weight of the water-saturated sediment less the initial sample weight of the dry preparation after mixing about 2 g protein preparation with about 40 ml water for 10 minutes and centrifuging at 1000 g for 15 minutes at 20° C.

### Oil Binding:

Oil binding capacity may be expressed in ml/g, i.e. millilitres of bound oil per gram of preparation, and is measured according to centrifuge determination methods as the volume of the oil-binding sediment after mixing 1.5 g protein preparation with 15 ml corn oil for 1 minute and centrifuging at 700 g for 15 minutes at 20° C.

### Exemplary Embodiment

200 g of a pumpkin seed press cake with an oil content of 23% by mass, which was obtained with the aid of a press at an average temperature of 75° C. with two passes through the press was dried in a dryer to obtain a water moisture content of 2.5% by mass, and the press cake was coarsely ground in a mortar. The crushed press cake was extracted 5 times, using 600 mL solvent (ethanol-water mixture with 7% by mass water content) each time. For this in the first stage 600 mL was added to the 200 g press cakes, stirred for 5 minutes at 50° C., then the agitator was switched off. The solid was allowed to settle for 30 minutes, then 300 mL of the supernatant was drawn off, and 600 mL solvent was added to this again. The following extraction steps were performed in the same way, 600 mL was added and 600 mL was drawn off each time. Then, the final raffinate or sediment was dried for 24 hours in a drying cabinet and subsequently sieved through a sieve with 1 mm mesh size. With sieving, it was possible to separate about 50% of the fractions of the integument obtained that could not be removed before pressing. In this way, the green colouration could be reduced and the brightness of the preparation improved. Sieving was followed by grinding to smaller than 250 μm.

The preparation had a pleasant, nutty flavour and a protein content of 76.4%, a protein solubility of 13.3% at pH 7 and an emulsifying capacity of 160 mL/g. The L*a*b measurement returned an L* value of 91.9. The following Tables 2 and 3 present the composition and functional properties of this preparation.

TABLE 2
Composition of the pumpkin seed protein preparation
compared with pumpkin seeds before treatment

| | | Ash | Ash | | | |
|---|---|---|---|---|---|---|
| | | (550° | (950° | | | |
| | DM | C.) | C.) | Protein | Oil | Sucrose |
| Preparation | [%] | [% DM] | [% DM] | [% DM] | [% DM] | [% DM] |
| Pumpkin protein | 94.2 | 10.8 | 8.8 | 76.4 | 4.4 | 1.1 |
| preparation | | | | | | |
| pressed, extracted | | | | | | |
| with ethanol | | | | | | |
| Pumpkin seeds | 96.5 | 5.6 | 4.3 | 35.9 | 50.9 | 0.7 |
| before treatment | | | | | | |

TABLE 3
Functional properties of protein preparations extracted with ethanol

| | | | Emulsi- | | Water | Oil |
|---|---|---|---|---|---|---|
| | Protein | | fying | Gel | binding | binding |
| Functional | solubility [%] | | cap. | conc. | [mL/g] | [mL/g] |
| properties | pH 4.5 | pH 7.0 | [mL/g] | [%] | [mL/g] | [mL/g] |
| Pumpkin | 9.4 | 13.3 | 160 | 6.0 | 2.2 | 1.3 |
| protein | | | | | | |
| preparation, | | | | | | |
| extracted with | | | | | | |
| ethanol | | | | | | |

### Application Example

20 g of the pumpkin seed preparation from the exemplary embodiment was substituted for egg in a muffin recipe. The functionality was very appealing, the muffins had a loose crumb, a brown crust and a very pleasant taste. The preparation is particularly well suited for applications such as nut or chocolate cakes.

1. Protein preparation produced from pumpkin seeds, with
a protein content of more than 60% by mass relative to a dry matter, and
a fat content less than 6% by mass relative to the dry matter, determined according to a Soxhlet method using hexane as solvent,
wherein the protein preparation has a brightness L* of greater than 70, determined according to CIE-L*a*b* color measurement with a d₉₀ particle size of the protein preparation less than 250 μm, or after grinding of the protein preparation to a d₉₀ particle size less than 250 μm.

2. Protein preparation according to claim 1,
which has a brightness L* of more than 80.

3. Protein preparation according to claim 1,
which has a residual content of integument of the pumpkin seeds of less than 10% by mass, relative to the dry matter of the preparation.

4. Protein preparation according to claim 1,
in which the protein content is more than 70% by mass.

5. Protein preparation according to claim 1,
in which the fat content is less than 4% by mass.

6. Protein preparation according to claim 1,
in which a sucrose fraction is less than 4% by mass relative to the dry mass.

7. Protein preparation according to claim 1,
in which the emulsifying capacity, determined according to the EC determination method stated in the description, is more than 250 ml/g.

8. Protein preparation according to claim 1,
which has a water binding capacity greater than 1 ml/g, determined according to AACC determination methods, and/or has an oil binding capacity greater than 1 ml/g, determined using centrifuge determination methods.

9. Protein preparation according to claim 1,
which has a fraction of ethanol, of >0.001% by mass, but which is less than 1% by mass.

10. Protein preparation according to claim 1,
which has a hexane fraction of >0.0005% by mass, but is less than 0.005% by mass.

11. Protein preparation according to claim 1,
which has a doo particle size of less than 150 μm.

12. Protein preparation according to claim 1,
to which in addition leguminous proteins from the group consisting of peas, lentils, beans, broad beans, peanuts and soya have been added.

13. An ingredient in foodstuffs, petfood and animal feeds comprising the protein preparation according to claim 1.

14. Method for obtaining a protein preparation from pumpkin seeds, according to claim 1, with at least the following steps:
shelling the pumpkin seeds, or provision of shelled pumpkin seeds;
mechanical partial de-oiling of the shelled pumpkin seeds, in which an average temperature of the shelled pumpkin seeds is maintained below 100° C.;
performing one or more extraction steps for the further de-oiling of the partially de-oiled pumpkin seeds, optionally after grinding or flaking, to a residual oil content of less than 6% by mass, in which a fraction of sucrose is also separated,
wherein the one or more extraction steps is/are carried out with one or more alcohol-water mixtures or with alcohol or hexane as solvent in the presence of water, each having a water content in the range between >6% by mass and <14% by mass for alcohols and between >6% by mass and <10% by mass for hexane, or wherein the multiple extraction steps are carried out with alcohol or hexane as a first and with water as a second solvent; and
drying the raffinate that is obtained after performance of the one or more extraction steps.

15. Method according to claim 14,
in which the pumpkin seeds are provided with a residual fraction of dry integument of less than 100% by mass, relative to the dry integument originally contained in the pumpkin seeds, or the integument is removed until this residual fraction remains.

16. Method according to claim 14,
in which the average temperature of the shelled pumpkin seeds is maintained below 80° C. during the mechanical partial de-oiling.

17. Method according to claim 14,
in which the further de-oiling of the partially de-oiled pumpkin seeds is carried out until a residual oil content of less than 4% by mass remains.

18. Method according to claim 14,
in which the one or more extraction steps is/are carried out with one or more alcohol-water mixtures as solvents or with alcohol as solvent in the presence of water, wherein the water fraction is in the range between >10% by mass and <14% by mass in each case.

19. Method according to claim 14,
in which the water fraction is selected to be highest in the first stage of a multistage extraction, and is lower in one or more subsequent stages.

20. Method according to claim 14,
in which a temperature of the solvent is selected to be between 30° C. and 75° C. during the performance of the one or more extraction steps.

21. Method according to claim 20,
in which a duration of the contact between the solvent and the partially de-oiled, optionally ground or flaked pumpkin seeds at temperatures of the solvent of >45° C. is selected to be between 30 minutes and 12 hours.

22. Method according to claim 14,
in which the mechanical partial de-oiling is carried out until a residual oil content between >8% by mass and <40% by mass remains.

23. Method according to claim 14,
in which the shelled pumpkin seeds are conditioned before the mechanical partial de-oiling by adjusting the moisture of the seeds to a water content in the seeds between 2 and 8% by mass.

24. Method according to claim 14,
in which the pumpkin seeds are warmed before the mechanical partial de-oiling to a temperature >40° C.

25. Method according to claim 14,
in which the pumpkin seeds are crushed coarsely to an edge length between 0.5 and 7 mm before the mechanical partial de-oiling.

26. Method according to claim 14, in which the partially de-oiled, optionally coarsely crushed, ground or flaked pumpkin seeds are conditioned before the one or more extraction steps is/are performed by reduction of the moisture to a residual moisture of <8% by mass.

27. Method according to claim 14, in which a particle size of the partially de-oiled pumpkin seeds is brought to a doo value of <2 mm before the one or more extraction steps is/are performed, wherein a fine grain fraction with a particle size less than 100 μm constitutes <50% by mass thereof.

28. Method according to claim 14,
in which the partially de-oiled pumpkin seeds are flaked to a flake thickness of <2 mm before the one or more extraction steps is/are performed.

29. Method according to claim 14,
in which the drying of the raffinate takes place at a temperature of <120° C.

30. Method according to claim 14,
in which the drying of the raffinate is carried out in a vacuum dryer, wherein at the end of the drying the pressure is reduced to <500 mbar.

31. Method according to claim 14,
in which a treatment of the raffinate with aqueous enzyme solutions or by fermentation is performed before the raffinate is dried.

32. Method according to claim 14,
in which after drying the raffinate is ground to a defined particle size distribution with a doo value of <500 μm.
